(19) United States
(12) Patent Application Publication
(10) Pub. No.: US 2016/0231876 A1
(43) Pub. Date: Aug. 11, 2016

(54) GRAPHICAL INTERACTION IN A TOUCH SCREEN USER INTERFACE

(71) Applicant: YIFEI WANG, Shanghai (CN)

(72) Inventor: YIFEI WANG, Shanghai (CN)

(21) Appl. No.: 14/616,306

(22) Filed: Feb. 6, 2015

(51) Int. Cl. G06F 3/0482; G06F 3/0488; G06F 3/041

(52) U.S. Cl. CPC G06F 3/0482; G06F 3/041; G06F 3/0488; G06F 2203/04108

(57) ABSTRACT

An input is received on a graphical interaction element floating in a touch screen user interface. A position of the graphical interaction element co-located with a display element is dynamically determined Based on the input, the position of the graphical interaction element, and the display element, an UI element including functions is dynamically determined. The UI element including functions is displayed in the position of the graphical interaction element on the touch screen user interface. A function from the UI element including functions is selected. The selected function is received and executed. A response is returned from the executed function, and displayed in the touch screen user interface.

### BACKGROUND

In electronic devices, when input devices such as mouse, track pad, etc., are used, an user is provided with a pointer on a screen, using which the user can position and perform operations such as click, hover, select, etc. However, in touch screen devices, a device does not know the position of the fingertip on the screen until it is touched. In touch screen devices, position and click information is generally obtained together. Accordingly, in touch screen devices, it is challenging to point to a specific position without performing any operation. Further, it is also challenging to hover over a specific element displayed in the touch screen user interface to initiate an operation.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating a touch screen user interface displaying a graphical interaction element, according to one embodiment.

FIG. 2 is a block diagram illustrating example architecture of graphical interaction element in a touch screen user interface, according to one embodiment.

FIG. 3 illustrates a user interface for displaying a tool tip pop-up on the graphical interaction element, according to one embodiment.

FIG. 4 illustrates a user interface for displaying a magnified display element on the graphical interaction element, according to one embodiment.

FIG. 5 illustrates a user interface for displaying a context menu on the graphical interaction element, according to one embodiment.

FIG. 6 illustrates a user interface for capturing a portion of screen and displaying a context menu, according to one embodiment.

FIG. 7 is a flow diagram illustrating a process of graphical interaction in a touch screen user interface, according to one embodiment.

FIG. 8 is a block diagram illustrating an exemplary computer system, according to one embodiment.

### DETAILED DESCRIPTION

Embodiments of techniques for graphical interaction in a touch screen user interface are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

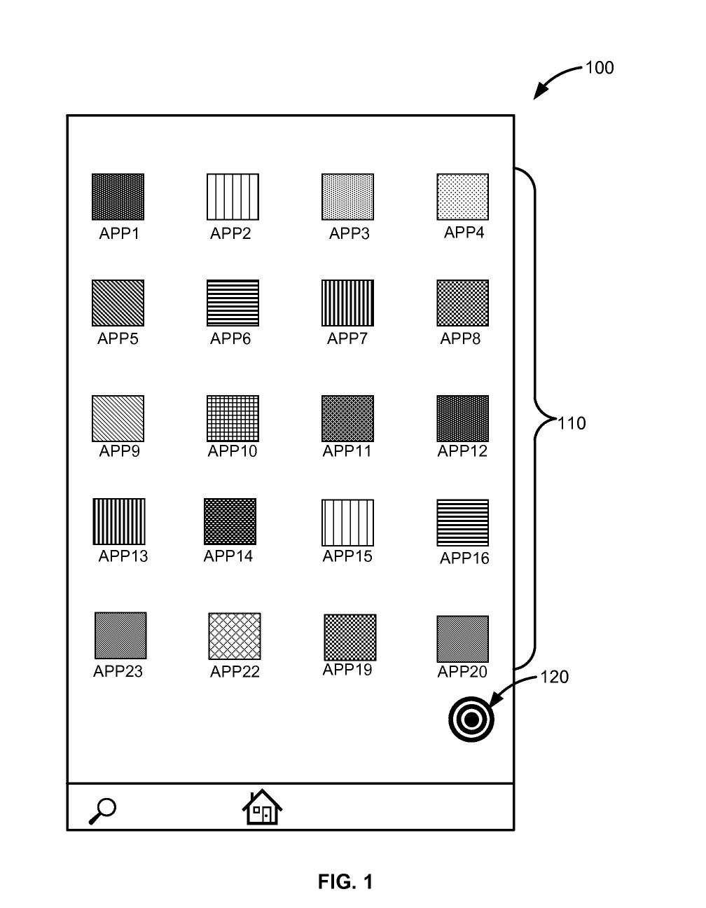

FIG. 1 is a block diagram illustrating touch screen user interface 100 displaying a graphical interaction element, according to one embodiment. Applications, also referred to as ‘apps’, are deployed in application stores also referred to as ‘app stores’. Users may download the ‘apps’ from the ‘app stores’ and install it in a client device such as a mobile device, an electronic tablet, a portable computer, etc. Application icons 110 of the installed ‘apps’ displayed in the user interface 100 of the client device may be referred to as display elements. The client device may be a multi-touch electronic device that the user can control through multi-touch gestures. Multi-touch gestures are predefined motions used to interact with multi-touch devices. Some examples of multi-touch gestures are hover, tap, double tap, long press, scroll, pan, pinch, rotate, etc. Users may use the multi-touch gestures to interact with the multi-touch electronic device and the applications executing or installed in the multi-touch electronic device.

Graphical interaction element 120 is shown in the touch screen user interface of the multi-touch electronic device. The graphical interaction element 120 floats in the touch screen user interface, and the user may move the graphical interaction element 120 to any position or location in the touch screen user interface. Floating refers to dynamic movement of the graphical interaction element 120 in correspondence with any of the multi-touch gesture received on the graphical interaction element 120. Floating is merely exemplary, the graphical interaction element may move, drag, glide, etc., in the graphical user interface. The graphical interaction element 120 acts like a pointer and may also be placed at a particular location on the graphical user interface. The graphical interaction element 120 can be of different shape, size, level of transparency, etc. The appearance of the graphical interaction element 120 can be customized by specifying or defining the shape, size, transparency, color, etc., in user settings of the multi-touch electronic device. The graphical interaction element 120 may be activated by one or more of the activation types such as multi-touch gestures like hover, tap, double tap, long press, etc. Individual activation types of the graphical interaction element 120 can associated or be bound to different user interface (UI) elements such as a window, menu, popup screen, context menu, widget, icon, pointer, cursor, selection, handle, text cursor, insertion point, tabs, magnifier, etc.

Based on the activation received as input on the graphical interaction element 120, an activation type is identified. A UI element corresponding to the activation type associated with the graphical interaction element 120 is identified and displayed. For example, when an activation type ‘tap’ is received on the graphical interaction element 120 co-located with or located at a proximity to a display element ‘APP15’, popup screen UI element may be displayed in response to the received activation type. Co-location of graphical interaction element with the display element is merely exemplary, visually graphical interaction element may appear to be superimposed on the display element, positioned in a close proximity to the display element, positioned at a pre-defined or user-defined proximity, positioned at a partially or completely overlapping proximity , etc. Since the transparency of the graphical interaction element can be user specified, the display element and the co-located/superimposed/overlaid graphical interaction element are visible. Similarly, other UI elements can be associated with other activation types for the graphical interaction element 120.

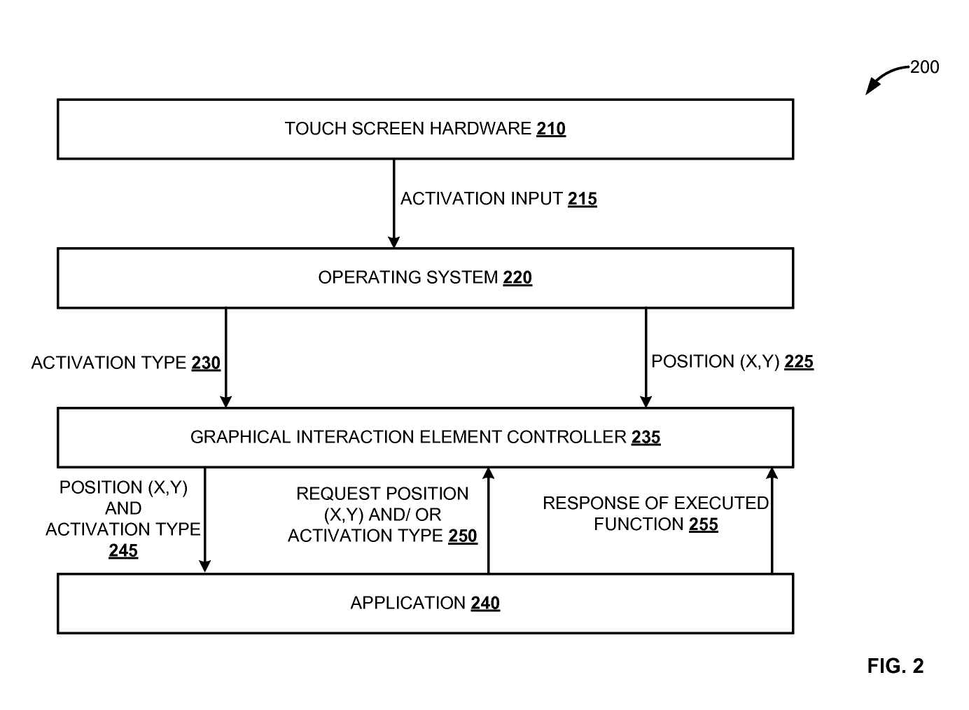

FIG. 2 is a block diagram illustrating example architecture 200 of graphical interaction element in a touch screen user interface, according to one embodiment. The graphical interaction element is in the touch screen user interface of a client device such as a multi-touch electronic device. When activation input is received at the touch screen hardware 210, the activation input 215 is sent to operating system 220 executing in a client device. The operating system 220 of the client device determines an activation type along with a position of the graphical interaction element. The position or location of the graphical interaction element may include the X and Y coordinates of location of the graphical interaction element in the touch screen user interface. X and Y coordinates represent horizontal and vertical addresses of any pixel or addressable point on the touch screen user interface. The position (X, Y) 225 coordinates determined at the operating system 220 along with the activation type 230 can be sent to the graphical interaction element controller 235.

The graphical interaction element controller 235 may be a device driver that is a computer program that operates or controls the graphical interaction element in the touch screen hardware 210. The graphical interaction element controller 235 may be a component in the operating system 220 and/or may be an interface between the operating system 220 and applications. The graphical interaction element controller 235 may send or push the position (X, Y) 225 coordinates of the graphical interaction element to any application requesting or any application co-located or in a proximity or positioned below the graphical interaction element such as application 240. The applications may register application functions with the graphical interaction element controller 235. Whenever an activation input 215 is received from the operating system 220 at the graphical interaction element controller 235 (not illustrated), the registered application functions may be invoked and the determined position (X, Y) coordinates and activation type 245 are pushed or sent to application 240.

For example, ‘app 1’, ‘app 2’ and ‘app 3’ are downloaded and installed from the ‘app stores’ and executing in the client device. The ‘apps’ executing in the client device are referred to as applications executing in the client device. The application icons of the installed ‘apps’ displayed in the client device may be referred to as display elements. The graphical interaction element may be associated with various ‘system defined functions’ when the graphical interaction element is activated while there may or may not be underlying application icons co-located with the graphical interaction element. The graphical interaction element may be associated with various ‘system defined functions’ depending on the type of activation received on the graphical interaction element. For example, for activation input 215 ‘press’ a ‘system defined function’ of displaying a ‘context menu of system functions’ may be associated. When a user performs ‘press’ activation on the graphical interaction element, the ‘press’ activation is sent to the operating system 220 executing in the client device. The operating system 220 determines the location or position (X, Y) 225 coordinate of the graphical interaction element, and determine the activation type 230 to be ‘press’. The operating system 220 registers operating system functions with the graphical interaction element controller 235. The determined position (X, Y) 225 coordinate and activation type 230 are sent to the graphical interaction element controller 235 since the operating system functions are registered with it. In response to the received position and activation type, the associated ‘context menu of system functions’ is displayed in the touch screen user interface, e.g., by the graphical interaction element controller 235. Various types of user interface (UI) elements such as ‘context menu of system functions’, ‘context menu of application functions’, a pop-up menu, a tool tip, etc., may appear to be superimposed on the graphical interaction element, positioned in a close proximity to the graphical interaction element, positioned at a pre-defined or user-defined proximity, positioned at a partially or completely overlapping proximity, etc.

In one embodiment, the graphical interaction element may be associated with various ‘application defined functions’ when the graphical interaction element is activated and there is an underlying application icon or application co-located with the graphical interaction element. The graphical interaction element can act as a pointer and dynamically interact with the application icon co-located or located within an overlapping proximity The graphical interaction element dynamically interacts with the application icon co-located with the graphical interaction element, or the application currently executing in the touch screen user interface. The graphical interaction element is associated with various ‘application defined functions’ depending on the activation type received on the graphical interaction element. For example, for activation input 215 ‘press’ an ‘application defined function’ for displaying a ‘context menu of application functions’ may be associated. When a user performs ‘press’ activation on the graphical interaction element that is co-located with an application icon, the ‘press’ activation input 215 is sent to the operating system 220 executing in the client device. The operating system 220 determines the location or position (X, Y) coordinates of the graphical interaction element, and determines the activation type to be ‘press’. The determined position (X, Y) 225 coordinates and the activation type 230 are sent from the operating system 220 to the graphical interaction element controller 235. The graphical interaction element controller 235 provides this information to the application 240 since application functions are registered with the graphical interaction element controller 235. In response to the received activation input 215 ‘press’, the application 240 provides the ‘context menu of application functions’ for display in the touch screen user interface from the application 240.

In one embodiment, application functions such as event handlers defined by the application 240 are registered with the graphical interaction element controller 235. The application 240 registers application functions using corresponding event handler interfaces. For the activation type 230 ‘press’, a corresponding event handler interface is identified and an event handler application function is invoked and executed. The result of execution is sent to the touch screen user interface. In one embodiment, the application 240 may request position (X, Y) and activation type 250 from the graphical interaction element controller 235. In response to the request received from the application 240, the requested position (X, Y) and activation type 245 are sent to the application 240. A user may choose to select a function from the displayed ‘context menu of application functions’ and the function is executed by the application 240. The response of executed function 255 is sent to the touch screen user interface for display.

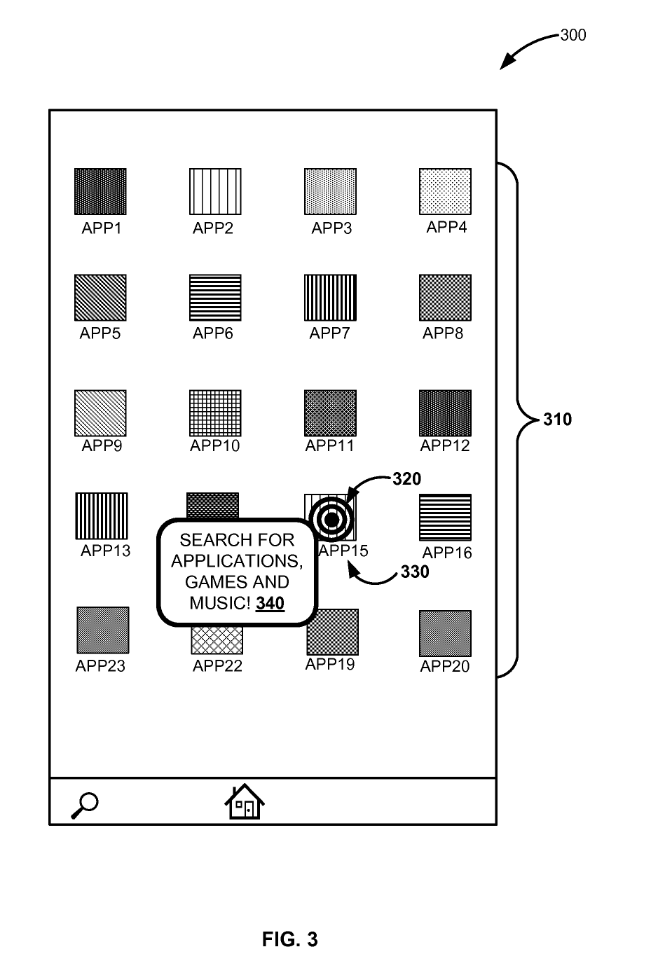

FIG. 3 illustrates user interface 300 for displaying a tool tip pop-up on a graphical interaction element, according to one embodiment. User interface 300 shows the applications ‘app 1’, ‘app 2’, ‘app3’, ‘app 4’,etc., installed and available in a client device. Application icons 310 displayed in the client device may be referred to as display elements. Graphical interaction element 320 is available or floating in the user interface 300. The graphical interaction element 320 is associated with various ‘system defined functions’ depending on the type of activation input received on the graphical interaction element 320.

For example, for an activation type ‘hover’ a ‘system defined function’ of displaying a ‘tool tip pop-up’ may be associated. When a ‘hover’ activation input is received on the graphical interaction element 320 that is co-located with the display element ‘app15’ 330, the ‘hover’ activation input is sent to the operating system executing in the client device. The operating system determines the position (X, Y) coordinates of the graphical interaction element 320 and also determines the activation type as ‘hover’. This information is sent to a graphical interaction element controller. The operating system functions are registered with the graphical interaction element controller. When application ‘app 15’ 330 is installed in the client device, a predefined description of ‘app15’ 330 is registered with the operating system. In response to the ‘hover’ activation input received, a ‘tool tip pop-up’ is displayed with the pre-defined description ‘search for applications, games and music!’ 340. The size and shape of the ‘tool tip pop-up’ displayed can be customized based on user settings.

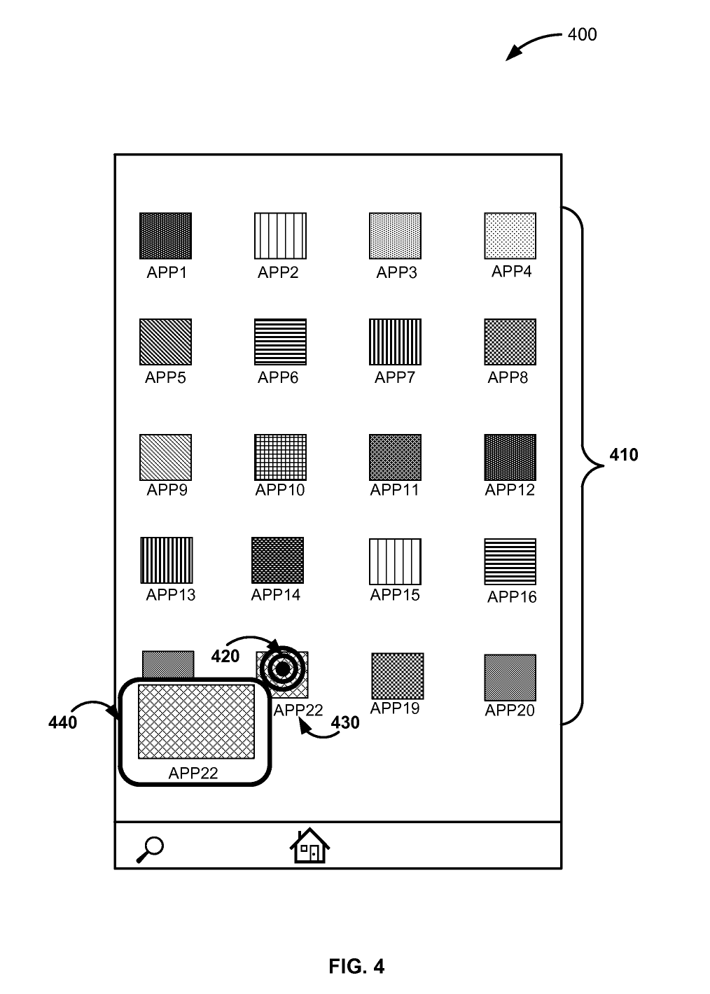

FIG. 4 illustrates user interface 400 to display magnified display elements at a graphical interaction element, according to one embodiment. User interface 400 shows the applications ‘app 1’, ‘app 2’, ‘app3’, ‘app 4’,etc., installed and available in a client device. Application icons ‘apps’ 410 displayed in the client device may be referred to as display elements. Graphical interaction element 420 is available or floating in the user interface 400. The graphical interaction element 420 is associated with various ‘system defined functions’ depending on the type of activation input received on the graphical interaction element 420. For example, for an activation type ‘hover’ on ‘app22’ 430 a ‘system defined function’ of pop-up menu with an option of a ‘magnifier’ is associated. When a user selects the ‘magnifier’ option on the pop-up menu, the ‘magnifier’ is activated, and screen content located below the graphical interaction element 420 is magnified and displayed. The ‘magnifier’ may display the screen content dynamically located below the graphical interaction element 420, until the ‘magnifier’ option in deselected or removed from selection. The activation type ‘hover’ is sent to the operating system executing in the client device. The operating system determines the position (X, Y) coordinates of the graphical interaction element 420 and also determines the activation type as ‘hover’. This information is sent to a graphical interaction element controller. In response to the ‘hover’ activation input received, the screen content located below the graphical interaction element, i.e., the display element ‘app22’ 430 is magnified and displayed. Magnifier may be a third party application or an in-built application in the client device. The magnifier receives current position of the graphical interaction element 420 and the screen contents of display element ‘app22’ 430 over/above which the graphical interaction element 420 hovers. The screen content of ‘app22’ 430 is magnified and displayed in the touch screen user interface as shown in display window 440.

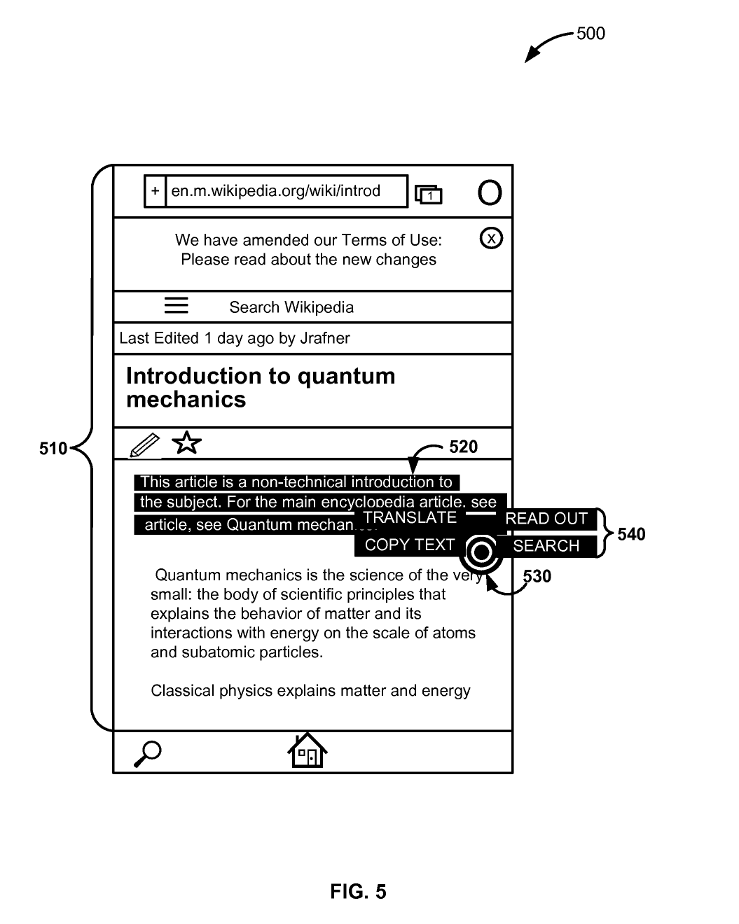

FIG. 5 illustrates user interface 500 to display a context menu in a graphical interaction element, according to one embodiment. User interface 500 shows browser application 510 executing in a client device. Some text information is displayed in the browser application 510. When a user selects a portion of text as shown in 520 using graphical interaction element 530, the activation input is sent to the operating system executing in the client device. The operating system determines the position (X, Y) coordinates of the graphical interaction element 530 and also determines the activation type as ‘selection’ along with the portion of text selected. This information is sent to a graphical interaction element controller. The graphical interaction element controller invokes the corresponding event handler interface and executes the event handler application function for ‘selection’ activation type. In response, a context menu 540 with functions such as ‘translate’, ‘read out’, ‘copy text’ and ‘search’ is displayed on the graphical interaction element 530. Based on the function selected, appropriate operation is performed on the selected portion of text. For example, when ‘read out’ function is selected, the selected portion of text is read out in the client device.

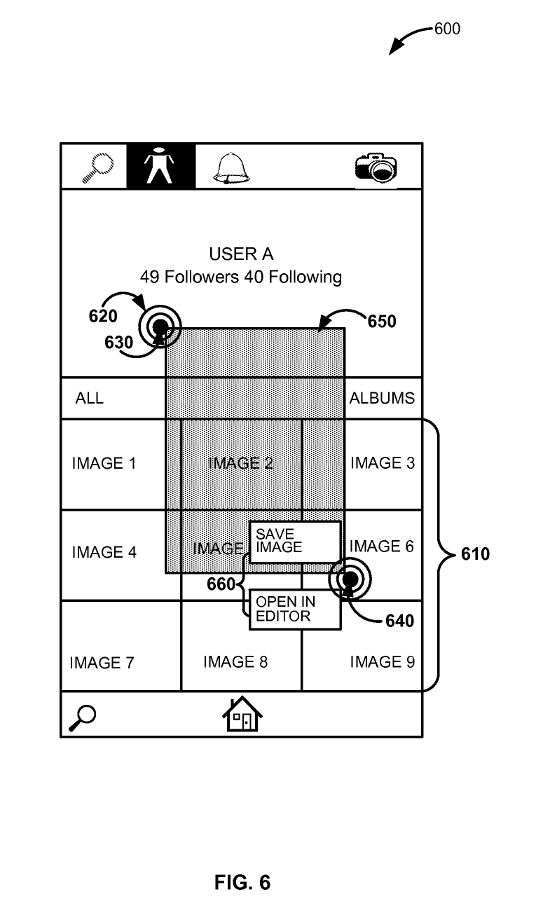

FIG. 6 illustrates user interface 600 for capturing a portion of screen and displaying a context menu, according to one embodiment. User interface 600 shows images 610 in a photo album displayed in a client device. A user may position graphical interaction element 620 at a starting point 630, and drag the graphical interaction element 620 to an end point 640 for selecting a portion 650 of images 610 displayed in the touch screen user interface. The selection activation input is sent to the operating system executing in the client device. The operating system determines the position (X, Y) coordinates of the graphical interaction element and also determines the activation type as ‘selection’ along with the portion 650 of images selected. This information is sent to a graphical interaction element controller. Appropriate event handlers are invoked, and in response, a ‘context menu of system defined functions’ 660 with functions such as ‘save image’ and ‘open in editor’ is displayed at the end point 640 of the graphical interaction element 620. Based on the function selected from the ‘context menu of system defined functions’ 660, appropriate operation is performed on the selected portion of images 650. For example, when the function ‘save image’ is selected, the images covered, either fully or partially, by the selected portion 650, are saved in the client device.

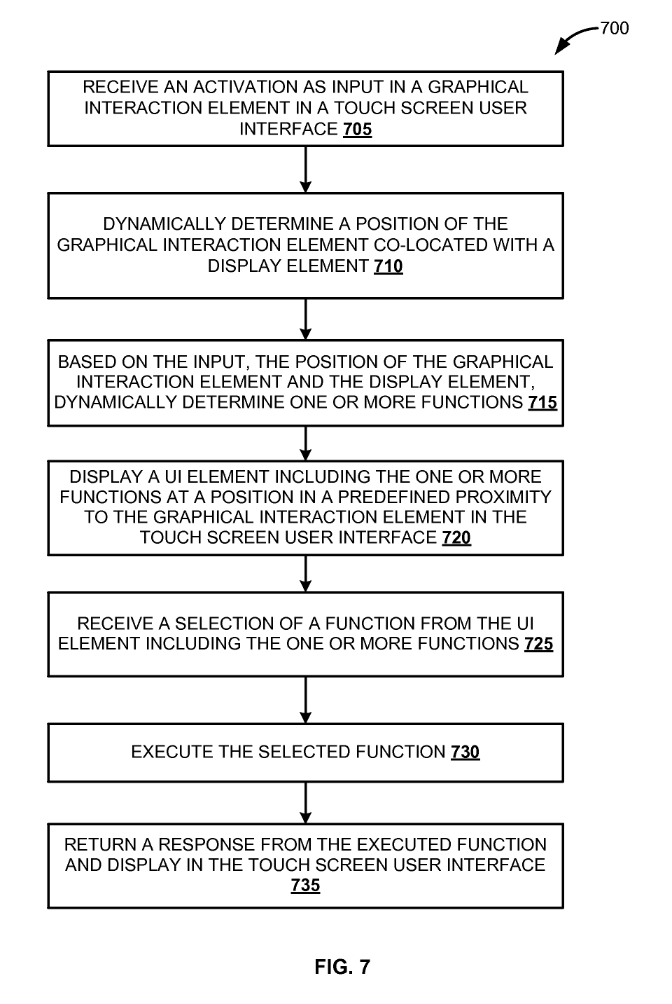

FIG. 7 is a flow diagram illustrating process 700 of graphical interaction in a touch screen user interface, according to one embodiment. At 705, an activation is received as input in a graphical interaction element in a touch screen user interface. At 710, a position of the graphical interaction element co-located with a display element is dynamically determined. At 715, based on the input, the position of the graphical interaction element, and the display element, one or more functions is dynamically determined. At 720, a UI element including the one or more functions is displayed at a position in a predefined proximity to the graphical interaction element in the touch screen user interface. At 725, a function is selected from the UI element including functions. At 730, the selected function is executed. At 735, a response from the executed function is returned and displayed in the touch screen user interface.

The various embodiments described above have a number of advantages. With the graphical interaction element user can point to a specific location in the screen without performing any operation. User can hover on any display element in the screen using the graphical interaction element. The graphical interaction element can interact with the underlying application and dynamically provide UI elements, therefore the graphical interaction element is not restricted to a set of predefined functions or a restricted set of UI elements.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

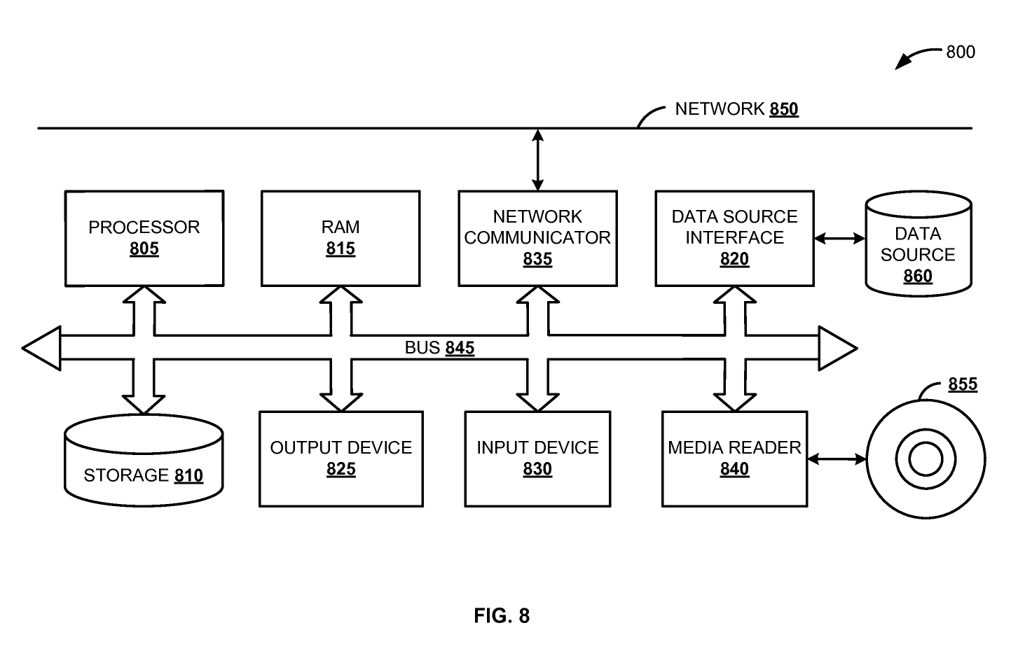

FIG. 8 is a block diagram illustrating an exemplary computer system, according to one embodiment. The computer system 800 includes a processor 805 that executes software instructions or code stored on a computer readable storage medium 855 to perform the above-illustrated methods. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. The output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
receive an input on a graphical interaction element in a touch screen user interface;
dynamically determine a type of the received input, a position of the graphical interaction element co-located with a display element;
based on the type of the input, the position of the graphical interaction element and the display element, dynamically determine one or more functions; and
display a UI element including the one or more functions, at a position in a predefined proximity to the graphical interaction element in the touch screen user interface.

2. The computer-readable medium of claim 1, wherein the display element is an application icon and the UI element including functions are context menu of application functions.

3. The computer-readable medium of claim 2, further comprising instructions which when executed by the computer further causes the computer to:
receive a selection of a function from the context menu of application functions;
execute the selected function in an application; and
return a response from the executed function to the touch screen user interface.

4. The computer-readable medium of claim 1, wherein dynamically determining the one or more functions is at a graphical interaction element controller.

5. The computer-readable medium of claim 1, wherein the UI element including functions is a context menu of system functions.

6. The computer-readable medium of claim 1, wherein the position of the graphical interaction element includes X and Y coordinates determined at an operating system.

7. The computer-readable medium of claim 1, wherein based on the input determine a type of activation on the graphical interaction element.

8. A computer-implemented method for graphical interaction on a touch screen user interface, the method comprising:
receiving an input on a graphical interaction element in a touch screen user interface;
dynamically determining a type of the received input, a position of the graphical interaction element co-located with a display element;
based on the type of the input, the position of the graphical interaction element and the display element, dynamically determining one or more functions; and
display a UI element including the one or more functions, at a position in a predefined proximity of the graphical interaction element in the touch screen user interface.

9. The method of claim 8, wherein the display element is an application icon and the UI element including functions are context menu of application functions.

10. The method of claim 9, further comprising instructions which when executed by the computer further causes the computer to:
receiving a selection of a function from the context menu of application functions;
executing the selected function in an application; and
returning a response from the executed function to the touch screen user interface.

11. The method of claim 8, wherein dynamically determining the one or more functions is at a graphical interaction element controller.

12. The method of claim 8, wherein the UI element including functions is a context menu of system functions.

13. The method of claim 8, wherein the position of the graphical interaction element includes X and Y coordinates determined at an operating system.

14. The method of claim 8, wherein based on the input determine a type of activation on the graphical interaction element.

15. A computer system for graphical interaction on a touch screen user interfaces, comprising:
receive an input on a graphical interaction element in a touch screen user interface;
dynamically determine a type of the received input, a position of the graphical interaction element co-located with a display element;
based on the type of the input, the position of the graphical interaction element and the display element, dynamically determine one or more functions; and
display a UI element including the one or more functions, at a position in a predefined proximity to the graphical interaction element in the touch screen user interface.

16. The system of claim 15, wherein the display element is an application icon and the UI element including functions are context menu of application functions.

17. The system of claim 16, further comprising instructions which when executed by the computer further causes the computer to:
receive a selection of a function from the context menu of application functions;
execute the selected function in an application; and
return a response from the executed function to the touch screen user interface.

18. The system of claim 15, wherein dynamically determining the one or more functions is at a graphical interaction element controller.

19. The system of claim 15, wherein the position of the graphical interaction element includes X and Y coordinates determined at an operating system.

20. The system of claim 19, wherein based on the input determine a type of activation on the graphical interaction element.
